(19) United States
(12) Patent Application Publication
(10) Pub. No.: US 2008/0172229 A1
(43) Pub. Date: Jul. 17, 2008

(54) Communication apparatus

(75) Inventor: Masaaki Imai, Kasugai-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-Shi (JP)

(21) Appl. No.: 12/007,349

(22) Filed: Jan. 9, 2008

(30) Foreign Application Priority Data
Jan. 12, 2007 (JP) 2007-004401

(51) Int. Cl. G10L 15/00

(52) U.S. Cl. 704/246; 704/E15.001

(57) ABSTRACT

A communication apparatus through which voice communication between a user and a communication partner is performed, including: a voice input device to which a user voice that is a voice of the user is inputted; a voice output device from which a partner voice that is a voice of the communication partner is outputted; and a controller including (a) a signal produce section which produces a message signal as an electric signal that is to be changed into a message voice and (b) a voice-characteristic recognition section which recognizes at least one of frequency characteristics of the user voice and the partner voice, and configured to prepare the message signal such that a frequency characteristic of the message voice is different from the recognized at least one of the frequency characteristics of the user voice and the partner voice.

### CROSS REFERENCE TO RELATED APPLICATION

The present application claims priority from Japanese Patent Application No. 20074004401, which was filed on Jan. 12, 2007, the disclosure of which is herein incorporated by reference in its entirety.

### BACKGROUND OF THE INVENTION

1. Field of the Invention

The present invention relates to a communication apparatus through which voice communication between a user and a communication partner is performed, and more particularly to a communication apparatus that outputs or outputs a message voice in a conversation.

2. Description of the Related Art

There is conventionally known a communication apparatus that outputs a message voice for informing a time elapsed from a start of a conversation, a phone call from another person, and so on in a phone conversation.

Patent Document 1 (Japanese Patent Application No. 9-116956) discloses a control-information-transmitting apparatus that recognizes a time in which no voice is inputted or outputted and that transmits control information in the recognized time.

### SUMMARY OF THE INVENTION

However, as disclosed in Patent Document 1, where a timing at which no voice is inputted or outputted is detected, and a message voice is outputted at the timing so as to be heard by a user, the message voice is likely to interfere with a conversation. In particular, when the message voice and a voice of a communication partner or the user are simultaneously outputted because the message voice is long, the message voice unfortunately interferes with a conversation or prevents the user from hearing the voice of the communication partner.

This invention has been developed in view of the above-described problems, and it is an object of the present invention to provide a communication apparatus which does not interfere with a conversation, even where a message voice is outputted in the conversation.

The object indicated above may be achieved according to the present invention which provides a communication apparatus through which voice communication between a user and a communication partner is performed, comprising: a voice input device to which a user voice that is a voice of the user is inputted; a voice output device from which a partner voice that is a voice of the communication partner is outputted; and a controller including (a) a signal produce section which produces a message signal as an electric signal that is to be changed into a message voice and (b) a voice-characteristic recognition section which recognizes at least one of frequency characteristics of the user voice and the partner voice, and configured to prepare the message signal such that a frequency characteristic of the message voice is different from the recognized at least one of the frequency characteristics of the user voice and the partner voice.

In the communication apparatus constructed as described above, one of the user and the communication partner can recognize that the message voice is outputted not by the other of the partner and the user, but by the communication apparatus. Thus, an interference with a conversation made via the communication apparatus can be prevented.

### BRIEF DESCRIPTION OF THE DRAWINGS

The above and other objects, features, advantages, and technical and industrial significance of the present invention will be better understood by reading the following detailed description of preferred embodiments of the invention, when considered in connection with the accompanying drawings, in which:

FIG. 1 is a block diagram showing an electric construction of a communication apparatus as an embodiment of the present invention;

FIG. 2 is a flow chart indicating a flow of a conversation processing;

FIG. 3 is a flow chart indicating a flow of a voice processing;

FIG. 4 is a flow chart indicating a flow of a voice processing in a second embodiment; and

FIG. 5 is a flow chart indicating a flow of a voice processing in a third embodiment.

### DESCRIPTION OF THE PREFERRED EMBODIMENTS

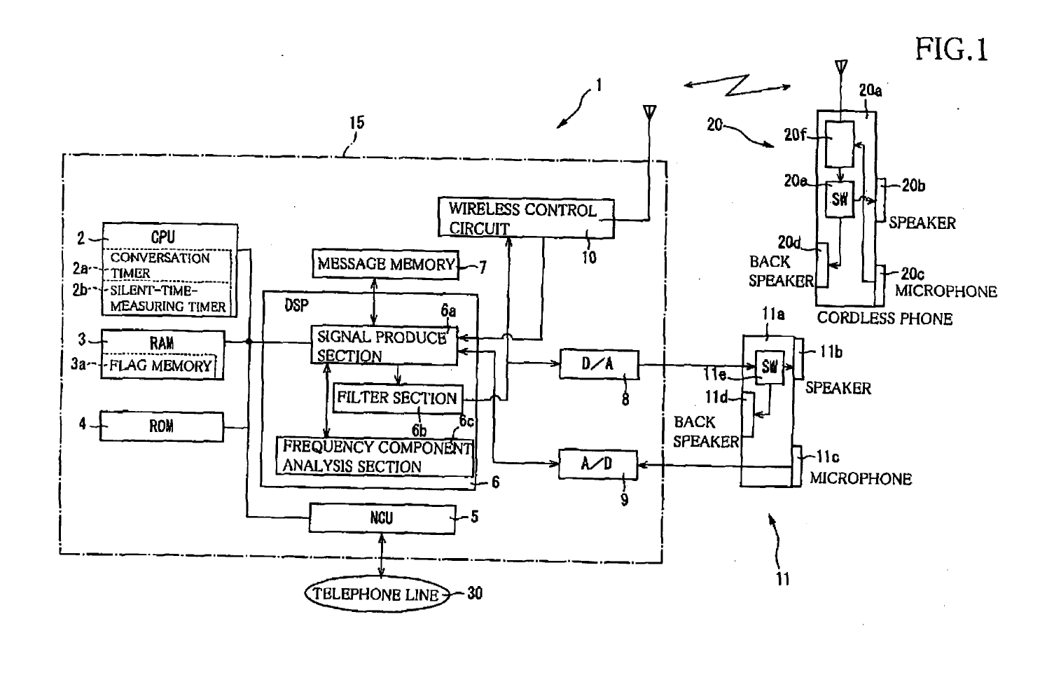

Hereinafter, there will be described preferred embodiments of the present invention by reference to the drawings. Initially, there will be explained, with reference to FIG. 1, an electric construction of a communication apparatus 1 of the present invention. FIG. 1 is a block diagram showing the electric construction of the communication apparatus 1. As shown in FIG. 1, the communication apparatus 1 is constituted by a base unit 15 and a cordless phone 20 as a kind of a handset. The base unit 15 mainly includes a Central Processing Unit (CPU) 2, a Random Access Memory (RAM) 3, a Read Only Memory (ROM) 4, a Network Control Unit (NCU) 5, a Digital Signal Processor (DSP) 6, a message memory 7, a digital-to-analog converter (D/A converter) 8, an analog-to-digital converter (A/D converter) 9, a wireless control circuit 10, and a handset 11.

The CPU 2, the RAM 3, the ROM 4, the NCU 5, and the DSP 6 are connected to each other via a bus. The message memory 7, the D/A converter 8, the A/D converter 9, and the wireless control circuit 10 are connected to the DSP 6. The D/A converter 8 and the A/D converter 9 are connected to the handset 11.

The CPU 2 is an arithmetic circuitry that performs various processings according to control programs stored in the ROM 4. The CPU 2 includes a conversation timer 2a and a silent-time-measuring timer 2b as a measuring section. The conversation timer 2a starts measurement of a time when a conversation is started. The silent-time-measuring timer 2b starts measurement of a time when voices fall silent owing to an interruption of a conversation. More specifically, the silent-time-measuring timer 2b is operable to measure at least one of a user silent time that is a time during which a user voice is not inputted to a microphone 11c or a microphone 20c (described below in detail) and a partner silent time that is a time during which the partner voice is not outputted from a speaker 11b or a speaker 20b (described below in detail).

The CPU 2 controls the DSP 6 such that one of regular messages is outputted when the silent-time-measuring timer 2b measures a predetermined time t in a state in which the conversation timer 2a measures a predetermined time T. On the other hand, the CPU 2 controls the DSP 6 such that one of irregular messages is outputted when the silent-time-measuring timer 2b measures the predetermined time t.

The regular messages include messages for informing about a time of day, a time elapsed from a start of a conversation, and so on. The irregular messages include messages for informing about a phone call from another person and, as information with respect to a function different from a telephone function, an arrival of a visitor.

The RAM 3 is a memory that allows data stored therein to be accessed at random and that temporarily stores variables and parameters when the CPU 2 performs one or ones of the control programs. Further, the RAM 3 includes a flag memory 3a that stores flags.

The NCU 5 is a circuit that controls a connection and a disconnection with a telephone line 30. The NCU 5 transmits dial signals for calling a communication partner and switches between the connection and the disconnection with the telephone line 30.

The DSP 6 is an integrated circuit for performing a signal processing of a digital voice. The DSP 6 includes a signal produce section 6a, a filter section 6b, and a frequency component analysis section 6c. The signal produce section 6a has, for example, a function for reading one of various message data stored in the message memory 7. The filter section 6b is operable to perform a filter processing on a message signal (i.e., an electric signal) produced on the basis of the read message data. The frequency component analysis section 6c analyzes frequency components of a voice to be inputted thereto.

The signal produce section 6a reads one of the message data stored in the message memory 7, produces, on the basis of a voice signal of a communication partner which is received via the NCU 5, a voice signal to output to the D/A converter 8, and outputs, to the NCU 5, a voice signal of a user inputted through the handset 11 or the cordless phone 20.

The signal produce section 6a reads one of the message data stored in the message memory 7 on the basis of a sampling frequency which is the same as that in recording, whereby a message voice to be converted from a message signal to be produced on the basis of the read message data is to be outputted such that a frequency characteristic thereof is the same as that of the message voice in recording.

In the filter section 6b, there are formed a band-pass filter and/or a low-pass filter provided by a digital filter, thereby changing a frequency characteristic of a message voice to be converted from the message signal which is produced by the signal produce section 6a.

The frequency component analysis section 6c can recognize a fundamental frequency of a partner voice that is a voice of a communication partner and can recognize frequency components (e.g., formants) of the partner voice. Where a voice is considered to be a synthesis of vibrations, the frequency component means, for example, a component with respect to at least one specific vibration which has a specific frequency or belongs to a specific frequency band. An amount of the frequency component is defined by intensity (e.g., amplitude, or the like) of the at least one specific vibration. In the following description, where the intensity is high, the amount of the frequency component will be referred to as “large.” On the other hand, where the intensity is low, the amount of the frequency component will be referred to as “small.”

There can be employed various means to recognize the frequency components. One example of the various means is that the frequency component analysis section 6c includes a plurality of band-pass filters, which divide the partner voice into components in a plurality of bands, and recognizes respective levels of the components in the bands. Another example of the various means is that the frequency component analysis section 6c recognizes a frequency envelope using fast Fourier transform (FFT). The frequency component analysis section 6c analyzes frequency components of a partner voice inputted via the NCU 5 as a voice signal. A result of the analysis of the frequency component analysis section 6c is inputted to the CPU 2.

In general, a fundamental frequency of a voice of a woman is higher, by about one octave, than that of a man. That is, the fundamental frequency of the voice of the woman is about twice that of the man. Frequency components of a voice of a woman are also higher than that of a man where the frequency components of the voices of the woman and the man are compared with each other in ones of the bands to which high frequency vibrations belong. Thus, the frequency component analysis section 6c analyzes frequency components of a voice, thereby recognizing whether a communication partner is a man or a woman.

In view of the above, the frequency component analysis section 6c is considered to be a voice-characteristic recognition section operable to recognize at least one of frequency characteristics of the user voice and the partner voice. More specifically, in this embodiment, the voice-characteristic recognition section recognizes the frequency characteristic of the partner voice.

In the message memory 7 as a data storage section, there are stored message data or voice data respectively corresponding to message voices whose frequency characteristics are different from each other. For example, message data for informing about a time of day, a time elapsed from a start of a conversation, and so on and message data for informing about an arrival of a phone call from another person are stored in a plurality voices such as voices of a man and a woman. Thus, the signal produce section 6a selectively reads suitable one of the message data stored in the message memory 7, thereby producing, on the basis of the read message data, one of the message signals that is to be converted into a message voice in the voice of the man or the woman.

The D/A converter 8 converts, into an analog signal, a digital signal as one of the message signals produced by the DSP 6 and a digital signal as a voice signal of a communication partner which is inputted via the NCU 5. Then, the D/A converter 8 outputs the converted analog signal to the handset 11.

The A/D converter 9 converts an analog signal converted by the microphone 11c provided on the handset 11 into a digital signal by sampling at a predetermined sampling frequency. Then, the A/D converter 9 transmits the converted digital signal to a communication apparatus of a communication partner via the NCU 5.

The wireless control circuit 10 performs wireless communication with the cordless phone 20, utilizing a frequency-hopping spread spectrum technology. The voice signals are transmitted and received each in the form of the digital signal by the wireless control circuit 10. A message signal, in the form of the digital signal, prepared by the DSP 6 is outputted from the filter section 6b and inputted to the wireless control circuit 10. A voice signal of a partner voice which is received from the telephone line 30 via the NCU 5 is also inputted, in the form of the digital signal to the wireless control circuit 10. The message signal and the voice signal of the partner voice are transmitted in wireless communication to the cordless phone 20 from an antenna connected to the wireless control circuit 10. A user voice inputted to the cordless phone 20 is converted into the digital signal and inputted to the wireless control circuit 10 in the wireless communication. Then, the voice signal of the user is inputted to the frequency component analysis section 6c and then the NCU 5, so as to be transmitted to the communication apparatus of the communication partner via the telephone line 30.

The handset 11 is provided by a casing 11a as a base body different from the base unit 15 and electrically connected thereto by, e.g., a cord. The handset 11 includes the speaker 11b as a first voice output device, the microphone 11c as a voice input device, a back speaker 11d as a second voice output device, and a switch circuit 11e.

The speaker 11b and the microphone 11c are formed on portions of one of surfaces of the casing 11a which portions are normally fitted or opposed to one of ears and a mouth of a user, respectively, when the handset 11 is held by the user. The back speaker 11d is formed on another portion of the casing ha which is located on one of surfaces thereof that is opposite to the surface thereof on which the speaker 11b and the microphone 11c are provided.

The switch circuit 11e switches an effective output device, from which a voice is to be outputted, between the speaker 11b and the back speaker 11d. Where a signal outputted from the D/A converter 8 is the message signal produced by the signal produce section 6a, the switch circuit 11e switches the effective output device to the back speaker 11d, that is, a message voice to be converted from the message signal is outputted from the back speaker 11d so as to be heard by a user. Where the signal outputted from the D/A converter 8 is a voice signal of a communication partner which is inputted via the NCU 5, the switch circuit 11e switches the effective output device to the speaker 11b, that is, a partner voice to be converted from the inputted voice signal is outputted from the speaker 11b.

The cordless phone 20 is provided by a casing 20a as a base body, performs the wireless communication via an antenna thereof with the base unit 15 and, like the handset 11, includes the speaker 20b as the first voice output device, the microphone 20c as the voice input device, a back speaker 20d as the second voice output device, and a switch circuit 20e. Further, the cordless phone 20 includes a wireless control circuit 20f. Each of the speaker 20b, the microphone 20c, the back speaker 20d, and the switch circuit 20e performs an operation similar to that of a corresponding one of the speaker 11b, the microphone 11c, the back speaker 11d, and the switch circuit 11e. Further, the speaker 20b, the microphone 20c, the back speaker 20d, and the switch circuit 20e have a positional relationship which is the same as that of the speaker 11b, the microphone 11c, the back speaker 11d, and the switch circuit 11e. The wireless control circuit 20f performs the wireless communication with the wireless control circuit 10 of the base unit 15. More specifically, the wireless control circuit 20f converts a voice signal received from the base unit 15 into an analog signal to output the converted analog signal to the switch circuit 20e. In addition, the wireless control circuit 20f converts a voice inputted to the microphone 20c into a digital signal to transmit the converted digital signal to the base unit 15 in the wireless communication. Thus, the cordless phone 20 permits a user to make a conversation via the telephone line 30 and to make a conversation with a communication partner who uses the handset 11 of the base unit 15. Further, the constructions of the handset 11 and the cordless phone 20 permit a user to recognize that a message voice is not made by a communication partner but outputted by the communication apparatus 1.

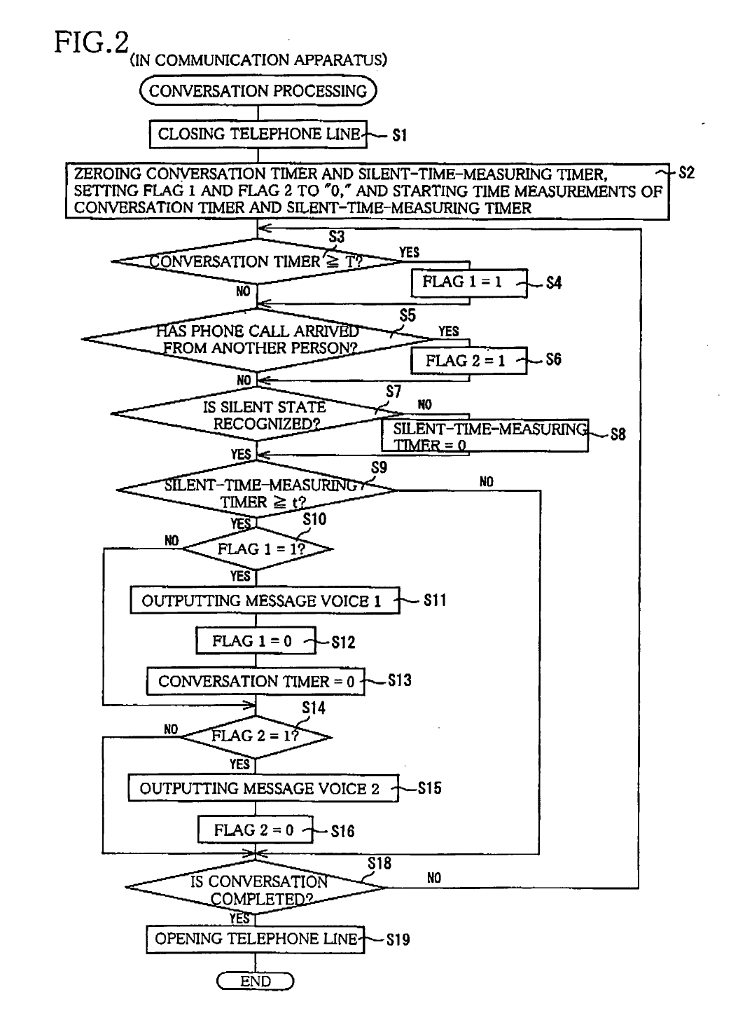

There will be next explained, with reference to FIG. 2, a conversation processing performed by the CPU 2. FIG. 2 is a flow chart indicating a flow of the conversation processing which is started when a user lifts the handset 11 in response to a phone call or when the user dials a communication partner. It is noted that, in the conversation processing of this embodiment, one of the regular message voices which is for informing about a time elapsed from a start of a conversation is outputted on every elapse of predetermined time T (e.g., five minutes), while one of the irregular message voices which is for informing a phone call is outputted where the phone call has arrived from another person.

Further, in this conversation processing, a flag 1 and a flag 2 are used. The flag 1 is set to “1” when the conversation timer 2a measures the predetermined time T at which the one of the regular message voices is outputted. The flag 1 is set to 0 where the time from the start of the conversation does not reach the predetermined time T. On the other hand, the flag 2 is set to “1” when the one of the irregular message voices is outputted. The flag 2 is set to “0”, where any of the irregular message voices is not outputted.

In this conversation processing, the telephone line 30 is closed (S1), so that a conversation between a user and a communication partner is started. Next, the conversation timer 2a and the silent-time-measuring timer 2b are zeroed, the flag 1 and the flag 2 are set to “0,” and each of the conversation timer 2a and the silent-time-measuring timer 2b is set to start to measure a time (S2). Subsequently, whether the measured time of the conversation timer 2a is equal to or longer than the predetermined time T or not is judged (S3). When the measured time of the conversation timer 2a is equal to or longer than the predetermined time T (S3: Yes), the flag 1 is set to “1” (S4).

Where the measured time of the conversation timer 2a does not reach the predetermined time T (S3: No), or where S4 has been executed, whether a phone call has arrived from another person or not is judged (S5). When the phone call has arrived from another person (S5: Yes), the flag 2 is set to “1” (S6).

Where the phone call has not arrived from another person (S5: No), or where S6 has been executed, whether a state in which a partner voice is not inputted is recognized or not is judged (S7).

Where the state is not recognized (S7: No), that is, where the partner voice is inputted, the silent-time-measuring timer 2b is zeroed (S8). Where the state is recognized (S7: Yes), that is, where the partner voice is not inputted, the measurement of the silent-time-measuring timer 2b is continued.

Next, whether the measured time of the silent-time-measuring timer 2b is equal to or longer than the predetermined time t or not is judged (S9). Where the measured time of the silent-time-measuring timer 2b is equal to or longer than the predetermined time t (S9: Yes), whether the flag 1 is set at “1” or not is judged (S10). Where the flag 1 is set at “1” (S10: Yes), a message voice 1 for informing the time elapsed from the start of the conversation is outputted (S11), that is, the signal produce section 6a produces a message signal for the message voice 1. Then, the flag 1 is set to “0” (S12), and the conversation timer 2a is zeroed and set to restart to measure a time (S13).

Where the flag 1 is not set at “1” (S10: No), or where S13 has been executed, whether the flag 2 is set at “1” or not is judged (S14). Where the flag 2 is set at “1” (S14: Yes), a message voice 2 for informing a phone call from another person is outputted (S15), that is, the signal produce section 6a produces a message signal for the message voice 2. Then, the flag 2 is set to “0” (S16).

Where the flag 2 is not set at “1” (S14: No), S16 has been executed, or the measured time of the silent-time-measuring timer 2b does not reach the predetermined time t in S9 (S9: No), whether the conversation is completed or not is judged (S18). When the conversation is completed (S18: Yes), the telephone line 30 is opened (S19), and then the conversation processing is completed. Where the conversation is not completed (S18: No), the processing returns to S3.

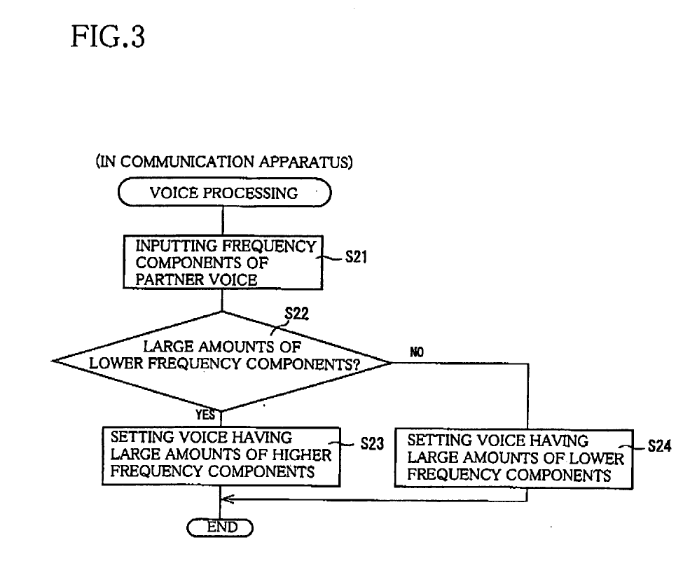

There will be next explained, with reference to FIG. 3, a voice processing performed by the CPU 2. FIG. 3 is a flow chart indicating a flow of the voice processing for controlling, on the basis of frequency components of a partner voice, the message signals prepared by the DSP 6. The voice processing is performed when a partner voice is started to be inputted.

In this voice processing, the frequency components analyzed by the frequency component analysis section 6c is initially inputted (S21). Subsequently, whether a partner voice has large amounts of lower frequency components or not is judged on the basis of the analyzed frequency components (S22). Where the partner voice has the large amounts of lower frequency components (S22: Yes), the signal produce section 6a is set so as to read, from the message memory 7, one of the message data based on which a message signal to be converted into a message voice having large amounts of higher frequency components is to be produced, and the filter in the filter section 6b is set to a flat setting in which message signals ranging from ones to be converted into message voices having large amounts of the lower frequency components to ones to be converted into message voices having large amounts of the higher frequency components are passed (S23). It is noted that the message voices having large amounts of the higher frequency components include voices of a woman and a child.

On the other hand, where the inputted voice has the small amounts of lower frequency components (S22: No), the signal produce section 6a is set so as to read, from the message memory 7, one of the message data based on which a message signal to be converted into a message voice having large amounts of the lower frequency components is produced, and the filter in the filter section 6b is set to the flat setting (S24). Where S23 or S24 has been executed, the voice processing is completed.

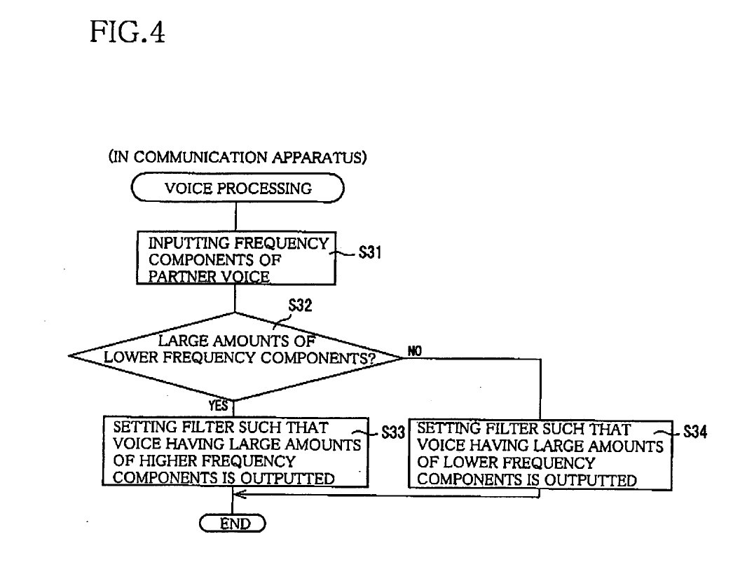

There will be next explained a second embodiment with reference to FIG. 4. In the first embodiment, a message voice converted from a message signal produced on the basis of a selected one of the message data stored in the message memory 7 is outputted, which voice has frequency components different from analyzed frequency components of a partner voice. However, in this second embodiment, a setting of the filter in the filter section 6b through which a message signal produced on the basis of a message data read from the message memory 7 is passed is changed, whereby a message voice which is to be converted from the message signal and which has the frequency components different from those of a communication partner is outputted. It is noted that, in this second embodiment, an electric construction of the communication apparatus 1 and processings other than a voice processing performed by the CPU 2 are the same as those in the first embodiment, and an explanation of which is dispensed with.

FIG. 4 is a flow chart indicating a flow of a voice processing in which the CPU 2 controls the filter section 6b to perform a filter processing on the message signal which is produced by the signal produce section 6a, on the basis of frequency components of an inputted partner voice, such that a frequency characteristic of a message voice to be converted from the message signal is different from that of the partner voice.

In this voice processing, the frequency components analyzed by the frequency component analysis section 6c are initially inputted (S31). Subsequently, whether an inputted partner voice has large amounts of lower frequency components or not is judged on the basis of the analyzed frequency components (S32). Where the voice has the large amounts of lower frequency components (S32; Yes), the signal produce section 6a is set so as to read a predetermined one of the message data from the message memory 7, and the filter in the filter section 6b is set to a setting in which relatively large amounts of higher frequency components are passed (S33).

On the other hand, where the inputted voice has the small amounts of lower frequency components (S32: No), the signal produce section 6a is set so as to read the predetermined one of the message data from the message memory 7, and the filter in the filter section 6b is set to a setting in which relatively large amounts of the lower frequency components are passed (S34). Where S33 or S34 has been executed, this voice processing is completed.

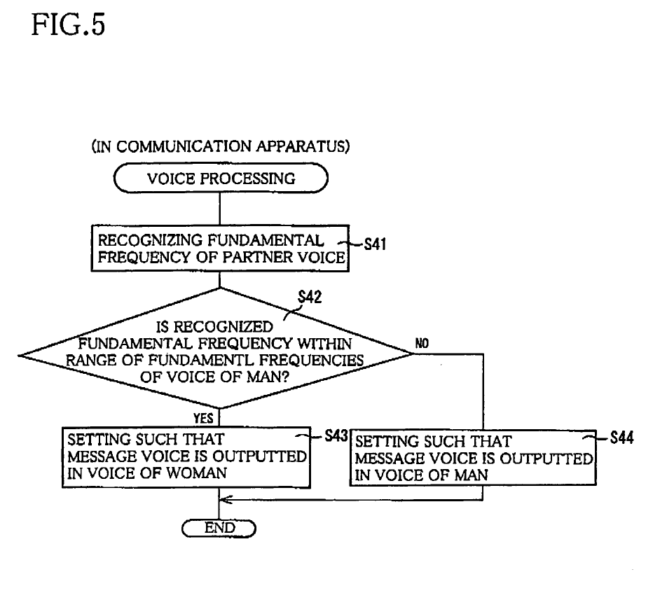

There will be next explained a third embodiment with reference to FIG. 5. In the first embodiment, a message voice having frequency components different from analyzed frequency components of a partner voice is outputted. However, in this third embodiment, a fundamental frequency of a partner voice is recognized, whereby a message voice having a fundamental frequency different from the recognized fundamental frequency of the partner voice is outputted. It is noted that, in this third embodiment, an electric construction of the communication apparatus 1 and processings other than a voice processing performed by the CPU 2 are the same as those in the first embodiment, and an explanation of which is dispensed with.

FIG. 5 is a flow chart indicating a flow of a voice processing in which the message signal is prepared such that a fundamental frequency of a message voice to be converted from the message signal is different from that of a partner voice. In this voice processing, the frequency components of a partner voice which are analyzed by the frequency component analysis section 6c are initially inputted, whereby a fundamental frequency of the partner voice is recognized on the basis of the analyzed frequency components (S41). Subsequently, whether the recognized fundamental frequency is within a range of fundamental frequencies of a voice of a man (S42). As described above, the fundamental frequency of the voice of the man is generally lower, by about one octave, than that of the woman, so that whether a communication partner is a man or a woman can be recognized on the basis of the fundamental frequency of the partner voice.

Where the recognized fundamental frequency is within the range of fundamental frequencies of the voice of the man (S42: Yes), the signal produce section 6a is set so as to read one of the message data based on which a message signal to be converted into a message voice recorded in a voice of a woman is to be produced, and the filter in the filter section 6b is set to the flat setting (S43). On the other hand, where the recognized fundamental frequency is without the range of fundamental frequencies of the voice of the man (S42: No), the signal produce section 6a is set so as to read one of the message data based on which a message signal to be converted into a message voice recorded in a voice of a man is to be produced, and the filter in the filter section 6b is set to the flat setting (S44). Where S43 or S44 has been executed, this voice processing is completed.

The communication apparatus 1 has a controller including the CPU 2, the DSP 6, and so on. In view of the above, the controller can be considered to prepare one of the message signal such that a frequency characteristic of a message voice converted from the message signal is different from at least one of the frequency characteristics of a user voice and a partner voice.

In the above-described embodiments, frequency components of a partner voice are analyzed, and a message voice having a frequency characteristic different from that of the partner voice is outputted on the basis of the analyzed frequency components. For example, where a partner voice has large amounts of lower frequency components, the filter is set to a setting in which relatively large amounts of higher frequency components are passed, so that a message voice having frequency components different from those of the partner voice can be outputted.

Further, whether a communication partner is a man or a woman is judged on the basis of a recognized fundamental frequency of a partner voice, whereby a message voice having a fundamental frequency different from that of the partner voice can be outputted.

Furthermore, after a conversation is started, whether a state in which a partner voice is not outputted is recognized or not is judged. Where the state is recognized, a message voice is outputted. Thus, even where the outputted message voice is long, a user can clearly distinguish the message voice from a partner voice, thereby preventing an interference with a conversation.

It is to be understood that the present invention is not limited to the details of the illustrated embodiment, but may be embodied with various changes and modifications, which may occur to those skilled in the art, without departing from the spirit and scope of the invention.

For example, in the above-described embodiments, a message voice having frequency components different from analyzed frequency components of a partner voice is outputted. Where the communication apparatus 1 is configured such that the message voice is also heard by a communication partner, frequency components of a user voice may be analyzed, and the message voice having frequency components different from those of the user voice and a partner voice may be outputted on the basis of the analyzed frequency components. Further, the communication apparatus 1 may be configured such that one of the regular messages is outputted where at least one of the user silent time and the partner silent time reaches the predetermined time t in a state in which the conversation timer 2a measures the predetermined time T.

Further, in the above-described embodiments, the DSP 6 analyzes frequency components, and the CPU 2 controls the message signals to be prepared by the DSP 6 on the basis of a result of the analysis inputted to the CPU 2, but the message signals may be controlled in the DSP 6.

Further, there may be a case where a user or a communication partner is changed to another person owing to, e.g., transferring of a phone call, and thus analyses of frequency components of a partner voice or a user voice may be repeatedly conducted.

Further, in the above-described embodiments, a message voice is outputted from the back speaker ld of the handset 11 or the back speaker 20d of the cordless phone 20, but a message voice and a partner voice may be outputted, together with each other, from the speaker 11b or the speaker 20b.

Further, in the above-described embodiments, in the message memory 7, there are stored a plurality of the message data based on which message signals to be respectively converted into message voices having fundamental frequencies or frequency characteristics different from each other are produced, and one of the message data is selected such that a fundamental frequency or a frequency characteristic of a message voice to be converted from a message signal to be produced on the basis of the selected message data is different from that of at least one of a user voice and a partner voice. However, a message signal produced on the basis of one of the message data stored in the message memory 7 may be read at a suitable sampling frequency, such that a fundamental frequency or a frequency characteristic of the message voice is different from that of the at least one of the user voice and the partner voice.

What is claimed is:

1. A communication apparatus through which voice communication between a user and a communication partner is performed, comprising:
a voice input device to which a user voice that is a voice of the user is inputted;
a voice output device from which a partner voice that is a voice of the communication partner is outputted; and
a controller including (a) a signal produce section which produces a message signal as an electric signal that is to be changed into a message voice and (b) a voice-characteristic recognition section which recognizes at least one of frequency characteristics of the user voice and the partner voice, and configured to prepare the message signal such that a frequency characteristic of the message voice is different from the recognized at least one of the frequency characteristics of the user voice and the partner voice.

2. The communication apparatus according to claim 1, configured such that the message voice is outputted so as to be heard by the user,
wherein the controller is configured to prepare the message signal such that the frequency characteristic of the message voice is different from at least the frequency characteristic of the partner voice.

3. The communication apparatus according to claim 1,
wherein the controller includes a measuring section configured to measure at least one of (a) a user silent time that is a time during which the user voice is not inputted to the voice input device and (b) a partner silent time that is a time during which the partner voice is not outputted from the voice output device, and
wherein the signal produce section is configured to produce the message signal when at least one of the user silent time and the partner silent time reaches a predetermined time.

4. The communication apparatus according to claim 3, configured such that the message voice is outputted so as to be heard by the user,
wherein the measuring section is configured to measure at least the partner silent time, and
wherein the signal produce section is configured to produce the message signal on a condition that the partner silent time reaches the predetermined time.

5. The communication apparatus according to claim 1,
wherein the voice-characteristic recognition section is configured to recognize at least one of a fundamental frequency of the user voice, as the frequency characteristic of the user voice, and a fundamental frequency of the partner voice, as the frequency characteristic of the partner voice, and
wherein the controller is configured to prepare the message signal such that a fundamental frequency of the message voice is different from at least one of the fundamental frequencies of the user voice and the partner voice.

6. The communication apparatus according to claim 1,
wherein the controller includes a data storage section configured to store a plurality of voice data respectively corresponding to a plurality of message voices each of which is the message voice and whose frequency characteristics are different from each other,
wherein the signal produce section is configured to read one of the plurality of voice data stored in the data storage section and to produce the message signal on the basis of the read one of the plurality of voice data, and
wherein the signal produce section is configured to read suitable one of the plurality of voice data such that a frequency characteristic of the message voice changed from the message signal to be produced is different from the recognized at least one of the frequency characteristics of the user voice and the partner voice.

7. The communication apparatus according to claim 1,
wherein the controller includes a filter section configured to perform a filter processing on the message signal produced by the signal produce section such that the frequency characteristic of the message voice is different from the recognized at least one of the frequency characteristics of the user voice and the partner voice.

8. The communication apparatus according to claim 1, further comprising a second voice output device which is different from the voice output device as a first voice output device,
wherein the message voice is outputted from the second voice output device and is not outputted from the first voice output device.

9. The communication apparatus according to claim 8, further comprising a handset having a plurality of surfaces,
wherein the voice input device and the first voice output device are provided on one of the plurality of surfaces while the second voice output device is provided on another of the plurality of surfaces.

10. The communication apparatus according to claim 8, further comprising a handset,
wherein the voice input device and the first voice output device are provided on portions of the handset which are fitted to a mouth and one of ears of the user, respectively, when the handset is used by the user, and
wherein the second voice output device is provided on a portion of the handset which is different from the portions thereof.
